(19) United States
(12) Patent Application Publication
(10) Pub. No.: US 2003/0194043 A1
(43) Pub. Date: Oct. 16, 2003

(54) Nuclear reactor system and method for automatically scramming the same

(76) Inventors: Abderrafi M. Ougouag, Idaho Falls, ID (US); William K. Terry, Shelley, ID (US)

Correspondence Address: Alan D. Kirsch, Esq., Idaho National Engineering & Environmental, Laboratory, 2525 North Fremont Avenue, Idaho Falls, ID, 83415, US

(21) Appl. No.: 10/122,104

(22) Filed: Apr. 12, 2002

(51) Int. Cl. G21C 7/00

(52) U.S. Cl. 376/336

(57) ABSTRACT

An automatically scramming nuclear reactor system. One embodiment comprises a control element moveable relative to a core of the reactor between an upper position and a lower position. An electrically-resistive element is positioned in thermal contact with the core, and has a variable resistance that changes in response to a change in temperature of the core. A release system is positioned adjacent the core. The release system is operatively associated with the electrically-resistive element and holds the control element in the upper position during a normal operating condition of the nuclear reactor system. The release system releases the control element when the temperature of the core changes from a safe operating temperature so that the control element automatically falls under the action of gravity to the lower position in the core.

### FIELD OF THE INVENTION

The invention generally pertains to nuclear reactor systems, and more specifically, to automatically scramming nuclear reactor systems.

### BACKGROUND OF THE INVENTION

There are over four-hundred nuclear power plants worldwide, providing nearly twenty percent of the world's electricity. Nuclear power plants function much like power-generating plants that are fueled by coal or oil. That is, either type of power plant generates heat that is used to heat water and produce steam, or to heat a gas. The steam or the gas, as the case may be, drives one or more turbines which in turn generate electricity. The difference, of course, is that heat is generated at a nuclear power plant by nuclear reactions (i.e., induced fission) instead of by burning coal or oil.

Induced fission takes place in a pressurized reaction vessel, or simply “the reactor”. The fuel for the reactor is provided by a suitable radioactive material (e.g., uranium-235 or plutonium-239) typically formed into either rods or “pebbles” that are arranged within the core of the reactor. As the fuel fissions, neutrons are released which bombard the nuclei of the other fuel atoms in the core of the reactor. The bombarded nuclei absorb the neutrons causing the nuclei to become unstable and split, releasing one or more neutrons which bombard the nuclei of yet other fuel atoms, and so on. The split atoms release energy in the form of radiation and heat.

During operation of the reactor, a coolant is passed through the core of the reactor to maintain the reactor at a normal operating temperature and keep it from overheating. The coolant may be either a gas-phase coolant (e.g., helium) or a liquid-phase coolant (e.g., water) that flows into the reactor, absorbs the heat produced during induced fission, and flows out of the reactor.

The heated coolant that flows out of the reactor may then be passed through a heat-exchanger. Water is also provided to the heat exchanger to absorb heat from the heated coolant. The coolant is then recirculated into the reactor. The heat absorbed by the water produces steam. This steam is used to drive the turbines that operate the generator and generate electricity. Alternatively, in a direct cycle gas-cooled reactor the cooling fluid is used directly to drive the turbines.

In some circumstances, the flow of coolant into the reactor may be insufficient to cool the reactor. As an example, the flow of coolant into the reactor may be interrupted by a blockage in the pipe system or failure of a pump, reducing or altogether stopping the flow of coolant into the reactor. Other causes may also cause the temperature of the core to exceed the normal operating temperature. When this happens, the reactor must be shut down so that the reactor does not overheat. Likewise, a decrease in temperature may also indicate a pending or potential problem with the reactor, in which case it must also be shut down.

The reactor is provided with one or more control elements that can be lowered into the reactor to slow and eventually stop the reactions occurring therein when the reactor exceeds or drops below a safe operating temperature. Control elements may be made from a variety of materials that absorb free neutrons. When the control elements are lowered into the reactor, the control elements absorb the neutrons instead of the neutrons being absorbed by the fuel, causing the reactor to shut down.

Typically, a number of monitors are used to determine how much heat is being generated in the reactor. For example, the monitors may measure the temperature in the reactor. When the temperature in the reactor changes from a safe operating condition, the monitors signal an emergency response system which in turn lowers the control elements into the reactor to shut it down. For safety reasons redundant monitors are commonly provided so that if one fails, another of the monitors will still signal the emergency response system of the unsafe operating condition so that it can shut down the reactor. However, the monitors must still signal the emergency response system when the unsafe condition occurs, thereby introducing delay and another potential point of failure. In addition, such redundant monitors can be complex and therefore expensive.

### SUMMARY OF THE INVENTION

An automatically scramming nuclear reactor system may comprise a core and a control element moveable relative to the core between an upper position and a lower position. An electrically-resistive element is positioned in thermal contact with the core and has a variable resistance that changes in response to a change in temperature of the core. A release system is positioned adjacent the core and is operatively associated with the electrically-resistive element. The release system holds the control element in the upper position during a normal operating condition of the nuclear reactor system. The release system releases the control element when the temperature of the core changes from a safe operating temperature so that the control element automatically falls under the action of gravity to the lower position in (or adjacent) the core.

A method for scramming a nuclear reactor system may comprise the steps of: Placing an electrically-resistive element in thermal contact with a core of the nuclear reactor system, the electrically-resistive element having a variable resistance that changes in response to a change in temperature of the core; connecting an electromagnet in series with the electrically-resistive element and a voltage source; and engaging a control element with the electromagnet, the control element being moveable with respect to the core between an upper position and a lower position, the electromagnet holding the control element in the upper position during a normal operating condition of the reactor, and releasing the control element when a temperature of the core changes from a safe operating temperature, the control element automatically falling under the action of gravity to the lower position when released by the electromagnet.

### BRIEF DESCRIPTION OF THE DRAWINGS

Illustrative and presently preferred embodiments of the invention are illustrated in the drawings, in which:

FIG. 1 is an illustration of a nuclear power plant;

FIG. 2 is a cross-sectional view of one embodiment of an automatically scramming nuclear reactor system; and

FIG. 3 shows one embodiment of an electromagnetic release system and control element for use with the automatically scramming nuclear reactor system.

### DESCRIPTION OF THE PREFERRED EMBODIMENT

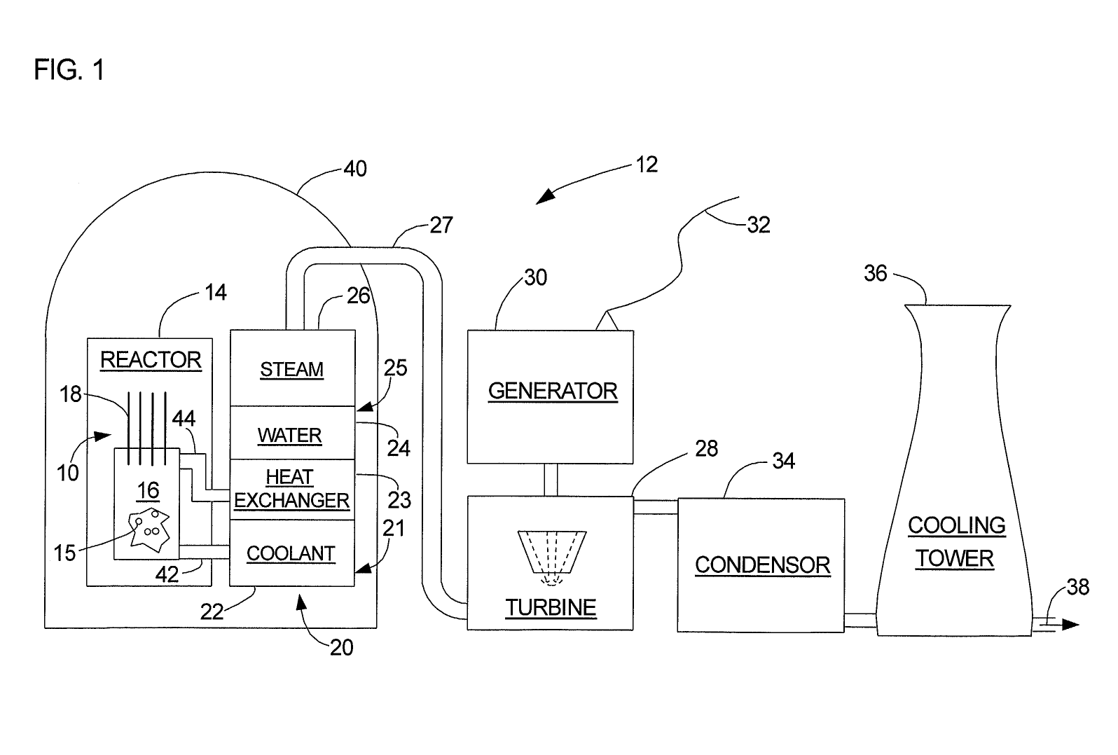

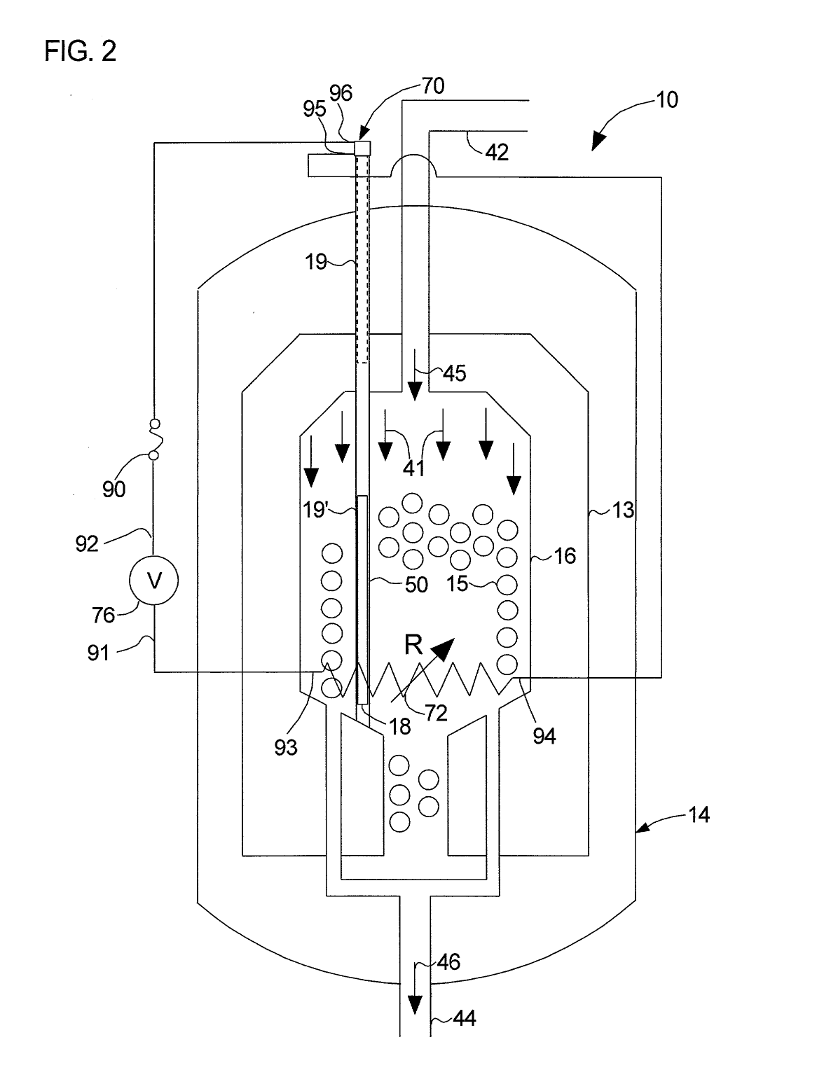

One embodiment of an automatic scramming system 10 according to the present invention is shown in FIG. 2 as it may be used in a nuclear power plant 12 (FIG. 1). Briefly, the nuclear power plant 12 may be of conventional design (with the exception of the presence of the invention) and may involve a fission reactor 14 for producing heat. A coolant 22 is provided to the core 16 of the reactor 14 (e.g., via inlet 42) and absorbs the heat produced during induced fission. The heated coolant 22 flows out of the reactor 14 (e.g., via outlet 44) and is passed through a heat exchanger 23. Water 24 is also provided to the heat exchanger 23 and absorbs the heat from the heated coolant 22 to produce steam 26. The coolant 22 can then be recirculated through the reactor 14. The steam 26 is used to drive one or more turbines 28, which operate a generator 30 to generate electricity 32. Of course in another embodiment, the coolant 22 may be used to drive the turbines 28 directly. In any event, if the temperature of the reactor 14 exceeds or drops below a safe operating temperature, the reactor 14 must be shut down.

According to the teachings of the present invention, an automatically scramming nuclear reactor system 10 (FIG. 2) may comprise a control element 18 that is movable relative to the core 16 of the reactor 14 between an upper position 19 and a lower position 19′. A voltage source 76 is electrically connected in series to an electrically-resistive element 72. The electrically-resistive element 72 is positioned in thermal contact with the core 16 of the reactor 14, and produces a variable resistance in response to changes in a temperature of the core 16. The electrically-resistive element 72 is also electrically connected in series to a release system 70 that is positioned adjacent the core 16 of the reactor 14. The release system 70 is in turn connected to the voltage source 76, thereby completing the circuit. Preferably, the circuit is electrically-insulated from the surroundings, as will be understood by one skilled in the art.

The voltage source 76 provides an electrical current to the release system 70 (e.g., an electromagnet) to hold the control element 18 in the upper position during a normal operating condition of the nuclear reactor system 10. If the temperature of the core 16 changes from a safe operating temperature, the electrically-resistive element 72 reduces the electrical current to the release system 70, causing the release system to automatically release the control element 18. Once released, the control element 18 falls under the action of gravity to the lower position in or adjacent the core 16 to shut down the reactor 14.

The automatically scramming nuclear reactor system 10 may be operated as follows according to the teachings of the invention. During a normal operating condition of the reactor, the temperature of the core 16 is maintained at a safe operating temperature. When operating at the safe operating temperature, the electrically-resistive element 72 provides little resistance to the electrical current flowing to the release system 70. Accordingly, the release system 70 holds the control element 18 in the upper position 19. If the temperature of the core changes from the safe operating temperature, the electrically-resistive element 72 produces greater resistance, thereby reducing the electrical current that flows to the release system 70. When this occurs, the release system 70 releases the control element 18. The control element automatically falls under the action of gravity into the core 16 to the lower position 19′ to slow the rate of the reaction and shut down the reactor 14.

Accordingly, the control element 18 is held outside of the reactor 14 when the core 16 is maintained at a safe operating temperature. When the temperature of the reactor 14 changes from the safe operating temperature, the control element 18 is automatically lowered into the core 16 of the reactor 14 under the force of gravity, causing the reactor 14 to shut down. External monitors may be provided for additional safety, but are not required for operation of the automatically scramming nuclear reactor system 10 of the present invention.

Having briefly described one embodiment of an automatically scramming nuclear reactor system 10, as well as some of the more significant features and advantages thereof, various embodiments of the invention will now be described in detail.

A nuclear power plant 12 is illustrated in FIG. 1 in which the automatically scramming nuclear reactor system 10 of the present invention may be implemented. According to this embodiment, the nuclear power plant 12 comprises a reactor 14. Fuel 15 is provided in a core 16 of the reactor 14 where induced fission occurs during operation. A cooling system 20 provides coolant 22 (e.g., a gas such as helium or a liquid such as water) in a primary coolant loop (i.e., between a coolant reservoir 21 and the reactor 14). During operation, the coolant 22 is pumped from the coolant reservoir 21 through the reactor 14. The heated coolant 22 is returned from the reactor 14 to a heat exchanger 23 that transfers the heat to water 24 provided in a secondary coolant loop (i.e., between a water reservoir 25 and the heat exchanger 23). The heated water 24 produces steam 26.

A steam collection system 27 provides a path for the steam from the water reservoir 25 to one or more steam-driven turbines 28. The turbines 28 are linked to a generator 30 which is operable by the rotation of the turbines 28 to generate electricity 32. Of course, in a direct-cycle system having a single loop, the coolant 22 directly drives one or more of the turbines 28.

A condenser 34 may be provided to collect the steam 26 from the turbines 28 and convert it to a liquid-phase. A return system (not shown) may provide a path to recirculate the liquid phase into the water reservoir 25 (e.g., a closed loop system). A cooling tower 36 may also be provided to cool the liquid-phase when it is to be discharged.

The reactor 14 and the cooling system 20 are preferably contained within a housing 40 to reduce the likelihood of radioactive gases or fluids leaking into the surrounding environment and to protect the reactor from external impacts (e.g., by vehicles or airplanes). The housing 40 may comprise a concrete liner surrounded by a steel containment vessel and an outer concrete building. Of course the housing 40 may comprise any suitable barriers based on various design considerations. The specific design is typically governed by safety and environmental regulations.

Various ancillary components (not shown) may also be contained within the housing 40, such as pumps, electronic controls, monitors, surveillance systems, etc. Such ancillary components are commonly associated with nuclear power plants 12, and therefore are not shown or described herein as they are well-understood and further description is not needed for an understanding of, or to practice the invention.

The nuclear power plant 12 may be operated to generate electricity 32 as follows. Radioactive material or fuel 15 (FIG. 2) is provided in the core 16 of the reactor 14 where it undergoes induced fission and releases heat. During the reaction, the coolant 22 flows through the core 16 of the reactor 14 to absorb heat from the reaction and maintain the reactor 14 at a normal operating temperature so that it does not overheat. The coolant 22 flows into the reactor 14, absorbs heat in the core 16, and flows out of the reactor 14. The heat absorbed by the coolant 22 is transferred to the water 24 by the heat-exchanger 23. The coolant is then recirculated into the reactor 14, and the heat absorbed by the water 24 produces steam 26.

The steam 26 is collected by the steam collection system 27 and used to drive the turbines 28, which in turn operate the generator 30 to generate electricity 32. The steam 26 is then collected from the turbines 28 by the condenser 34 and converted to a liquid phase. The liquid phase may be returned to the water reservoir 25 in a closed system to enhance the efficiency of the nuclear power plant 12. Alternatively, the at least a portion of the liquid phase may be passed through the cooling tower 36 and then discharged into the environment (e.g., as indicated by arrow 38).

The reactor 14 is shown in more detail in FIG. 2. The reactor 14 may comprise a sealed vessel 13 containing a core 16. As previously discussed, the fuel 15 may comprise any suitable radioactive material and may be formed into “pebbles” and provided in the form of a “bed” within the core 16 of the reactor 14. Such a reactor is commonly referred to as a pebble-bed reactor.

For purposes of illustration, the reactor 14 may be patterned on the South African utility Eskom pebble-bed modular reactor (PBMR). Exemplary design parameters for such a reactor are given in Table 1.

TABLE 1

| Core height | 10 meters (m) |
|---|---|
| Core diameter | 3 m |
| Fuel | UO₂ |
| Reflector material | graphite |
| Reflector thickness | 1 m (all around) |
| Fuel packing fraction in core | 0.61 |

Also according to one exemplary embodiment, the fuel 15 may comprise TRISO-coated uranium oxide (UO₂) microspheres embedded in a spherical graphite matrix inside a shell of pure graphite. The “pebbles” 15 are packed in the core 16 of the reactor 14 with a packing fraction of about 0.61, although this may vary in other designs.

It is noted that the fuel concentration may be adjusted to produce a critical core 16 when the control elements 18 are suspended above the reactor 14. It is further noted that the reactor 14 described in Table 1 is merely exemplary of one reactor that may utilize the automatic scramming system 10 of the present invention. Indeed, the invention is not limited to use with a pebble bed reactor and may be used with any suitable reactor, now known or that may be developed in the future. For example, the invention may be used with a reactor having a prismatic core.

The cooling system 20 provides the coolant 22 into the core 16 of the reactor 14 through an inlet 42. For example, the coolant 22 may be provided into the reactor 14 in a downward flow, as illustrated by arrow 45 in FIG. 2. The coolant 22 flows through the core 16 of the reactor 14 in a downward direction as illustrated by arrows 41, and is exhausted from the core 16 through the outlet 44 in the direction of arrow 46, as shown in FIG. 2.

Of course other embodiments of the cooling system 20 are also contemplated as being within the scope of the invention. By way of example, the cooling system 20 may comprise an upward flowing coolant 22. Similarly, the coolant 22 may comprise any suitable gas and/or liquid.

According to the teachings of the invention, a control element 18 is provided that is movable between an upper position 19 above the core 16 of the reactor 14, and a lower position 19′ within, or adjacent the core 16 of the reactor 14. The control element 18 is made of any suitable material that absorbs neutrons. Hence, when the control element 18 is lifted from the core 16 of the reactor 14 (e.g., into position 19), the reaction is allowed to take place therein. Likewise, when the control element 18 is lowered into the core 16 of the reactor 14 (e.g., into position 19′), the control element 18 absorbs neutrons and slows the rate of reaction, eventually causing the reactor 14 to shut down.

Any suitable lift system may be provided for raising the control element 18 from the core 16 of the reactor 14 (e.g., into position 19). However, a detailed description of the lift system is not required to understand the teachings of the invention. Suitable lift systems are well-understood in the art and can be readily provided for use with the present invention.

The particular design of the control element 18 may vary according to the teachings of the invention as discussed in further detail below. Design parameters for one embodiment of a cylindrical-shaped control element 18 are given in TABLE 2.

TABLE 2

| Design Parameter | Value |
|---|---|
| Control element material | boron carbide |
| Control element length | 1 m or 2 m |
| Control element diameter | 1 cm or 2.5 cm |
| Control element cladding material | stainless steel |
| Control element cladding thickness | 1 mm |

Of course the embodiment of the control element 18 given in TABLE 2 is merely exemplary. In other embodiments, for example, the control element 18 may be shaped as a sphere and may have any suitable dimensions. Accordingly, it is noted that other suitable designs of the control element 18 are also possible for use with the automatic scramming system 10 and will become apparent to one skilled in the art after having become familiar with the teachings of the present invention.

The control element(s) 18 are designed with sufficient shutdown reactivity. That is, the control elements 18 are designed to absorb enough neutrons when lowered into the core 16 that the reaction slows and eventually stops, shutting down the reactor 14. The change in reactivity resulting from insertion of the control elements 18 into the core may be modeled, as shown in Table 3 for three combinations of control element length and diameter.

TABLE 3

| | Design | Design | Design |
|---|---|---|---|
| | 1 | 2 | 3 |
| Control element length (m) | 1.0 | 1.0 | 2.0 |
| Control element diameter (cm) | 1.0 | 2.5 | 2.5 |
| Control element mass (kg) | 0.244 | 1.82 | 3.64 |
| k_{eff} (withdrawn) | 1.00441 | 0.98793 | 0.98793 |
| k_{eff} (inserted) | 0.99940 | 0.97252 | 0.96452 |
| Reactivity (4 elements) ($) | 0.244 | 1.8 | 3.6 |

The results presented in Table 3 indicate that Design 1 may be insufficient for a secure reactor scram, but may be sufficient to maintain the reactor in a shutdown state. After the core 16 of the reactor 14 cools following shutdown, the inserted control elements 18 would prevent re-criticality. Even Design 2 provides marginal scram reactivity. However, Design 3 provides ample shutdown reactivity with control elements 18 that can be readily supported above the core 16 of the reactor 14 according to the teachings of the present invention.

Of course it is understood that the values presented in Table 3 are merely exemplary of the shutdown reactivity of the control elements 18, and that the shutdown reactivity of the control elements 18 may be determined for any of a variety of different designs of the control elements 18. Likewise, it is understood that the mass of the control elements 18 may vary based on the strength of the lift system. In other exemplary embodiments, the mass of the control elements 18 may be 10 kg or even higher.

It is also noted that the automatic scramming system 10 of the present invention may comprise any suitable number of control elements 18. In one embodiment there are four control elements arranged in a circle having a radius of 75 cm. However, the particular arrangement of the control element(s) 18 in or adjacent the core 16 of the reactor 14 will depend on various design considerations.

One or more guides 50 may also be provided according to the teachings of the invention. The guide 50 may comprise a tube that is provided in the vessel 13 of the reactor 14. For example, the guide 50 may be embedded in the core 16 as shown in FIG. 2, or in the reflector (not shown). Other suitable configurations are also possible. The guide 50 may be manufactured from any suitable material, such as but not limited to stainless steel. Where the guide 50 is a tube configuration, it may have lateral perforations to prevent pressurization of the fluid therein as the control element 18 moves therein.

Also according to the teachings of the invention, the automatic scramming system 10 comprises a release system 70 positioned adjacent (e.g., above) the reactor 14 and an electrically-resistive element 72 positioned in thermal contact with the core 16 of the reactor 14. For example, the electrically-resistive element 72 may be positioned within or near the core 16. A voltage source 76 may provide electrical current to the release system 70. Also, a fuse 90 may also be provided to limit the electrical current provided to the release system 70.

According to one embodiment, a first terminal 91 of the voltage source 76 is electrically connected to a first lead 93 of the electrically-resistive element 72. A second lead 94 of the electrically-resistive element 72 is electrically connected to a first lead 95 of the release system 70. A second lead 96 of the release system 70 is in turn electrically connected to a second terminal 92 of the voltage source 76, thereby completing the circuit.

Of course it is understood that other embodiments are also contemplated as being within the scope of the invention. In another exemplary embodiment, a calibration resistor may be provided in series to calibrate the circuit and compensate for aging and radiation effects on the electrically-resistive element 72.

The voltage source 76 provides electrical current in the circuit previously described. The design of the electrically-resistive element 72 is such that it produces little resistance to the flow of electrical current in the circuit. Accordingly, sufficient electrical current is provided to the release system 70 so that it holds the control element 18 in the upper position 19 above the core 16 of the reactor 14.

In one embodiment, the design of the electrically-resistive element 72 is also such that as the temperature of the core 14 increases, the electrically-resistive element 72 produces more resistance to the flow of the electrical current in the circuit. When the temperature of the core 14 exceeds a safe operating temperature, the electrically-resistive element 72 produces so much resistance to the flow of the electrical current in the circuit that the release system 70 is no longer able to hold the control element 18, causing the control element 18 to fall under the action of gravity into the lower position 19′ in the core 16 of the reactor 14.

In another embodiment, the design of the electrically-resistive element 72 is such that as the temperature of the core 14 decreases, the electrically-resistive element 72 produces more resistance to the flow of the electrical current in the circuit. Such may be the case where a lower temperature is indicative of a pending or potential problem with the operation of the reactor 14. Of course it is understood that both embodiments of the electrically-resistive element 72 may be used (e.g., on separate circuits) to maintain operation of the reactor 14 within a safe range of operating temperatures (e.g., an upper and lower bound).

It is noted that any suitable voltage source 76 may be provided according to the teachings of the invention. A suitable backup voltage source may also be provided (e.g., a battery or electrical generator). In one embodiment, the voltage source is an alternating current (AC) source rectified to direct current. However, in other embodiments, the voltage source may be a direct current (DC) source.

It is also noted that the electrically-resistive element 72 may be manufactured of any suitable material (e.g., iron, copper), wherein the resistance is variable in response to changes in temperature. The electrically-resistive element 72 may also be made of, or encased within a corrosion-resistant material. According to preferred embodiments, the resistance of the electrically-resistive element 72 changes as the temperature changes.

According to one exemplary embodiment, the electrically-resistive element 72 is manufactured from iron. Iron melts at a temperature of about 1530 degrees Celsius and will not melt when exposed to the maximum expected temperature of the core 16. Iron also has a temperature coefficient of resistance of about 0.005. Accordingly, a temperature increase of about 100 degrees Celsius causes about a 50% increase in resistance, which in turn reduces the current provided to the release system 70 by about 33%, neglecting the resistance in the balance of the circuit.

The electrically-resistive element 72 may also be made of other suitable material or combination of materials, which will become apparent to one skilled in the art after having become familiar with the teachings of the present invention. In addition, more than one resistive element 72 may be provided at various positions in the core 16 of the reactor 14.

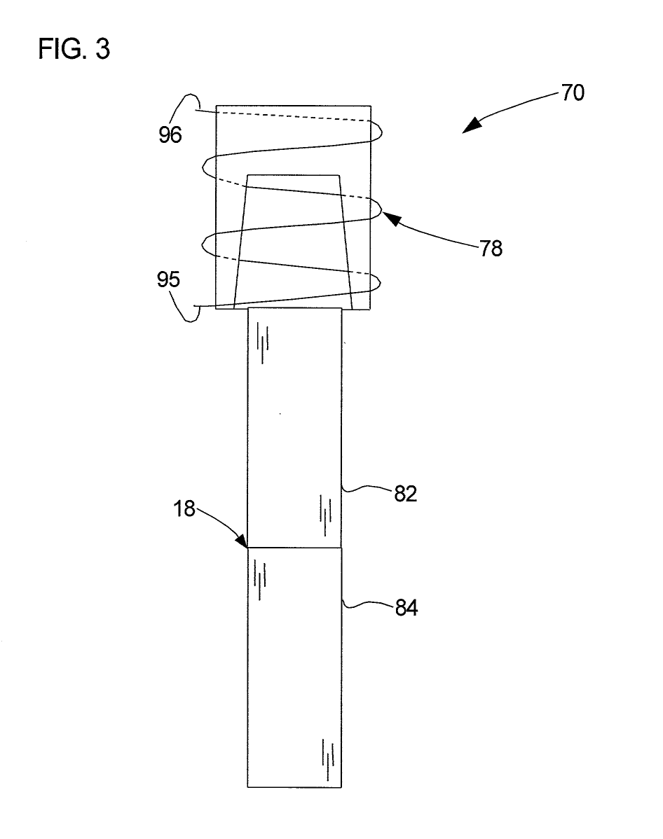

One embodiment of the release system 70 is shown in more detail in FIG. 3, wherein it comprises an electromagnet. The design and operation of electromagnets are well understood in the art. Briefly, electromagnets comprise a coil of wire. Electrical current flowing through the coil of wire generates a magnetic field. This magnetic field may be used to draw an entity of opposite polarity toward the coil of wire.

The release system 70 of the present invention may comprise a coil of wires 78. Accordingly, electrical current provided to the release system 70 flows through the coil of wires 78 and generates a magnetic field (not shown). The strength of the magnetic field is proportional to the flow of current through the coil of wires 78. When the electrical current provided to the release system 70 is reduced, the strength of the magnetic field decreases, and vice versa.

Also according to this embodiment, the control element 18 may comprise a ferromagnetic portion 82 and a control material portion 84. The ferromagnetic portion 82 of the control element 18 is preferably designed so that the magnetic field generated in the coil of wire 78 of the release system 70 will hold the control element 18 in a raised position when the resistance of the electrically-resistive element is low (i.e., such as would be produced by core temperatures during a normal operating condition of the reactor 14), as will be explained in more detail below.

The automatic scramming system 10 may be operated as follows according to one embodiment of the invention. When the core 16 is maintained at a safe operating temperature (e.g., by cooling system 20), the electrically-resistive element 72 provides little resistance to the flow of electrical current to the release system 70. As the electrical current flows through the coiled wires 78 of the release system 70, it generates a magnetic field. The magnetic field acts on the ferromagnetic portion 82 of the control element 18 when it is positioned near the release system 70 to hold the control element 18 in the upper position 19 above the core 16 of the reactor 14.

When the control element 18 is withdrawn from the core 16 of the reactor (e.g., in upper position 19), the reaction proceeds therein, generating heat for producing electricity as discussed above. During operation, the temperature of the core 16 of the reactor 14 may change from the safe operating temperature. For example, the cooling system 20 may fail or be shut off, causing the temperature of the reactor 14 to increase. Likewise, the coolant path may become obstructed, also causing the temperature of the reactor 14 to increase. In such an event, it may be necessary to shut down the reactor 14 before it overheats. Alternatively, a decrease in temperature may be indicative of a pending or potential problem with the operation of the reactor 14, also making it necessary to shut down the reactor 14 before such a problem occurs.

According to the teachings of the invention, when the temperature of the core 16 of the reactor 14 changes from the safe operating temperature (e.g., exceeds or drops below, as the case may be), the control element 18 is automatically lowered into the core 16 under the action of gravity to shut down the reactor 14. That is, as the temperature of the core 16 of the reactor 14 changes, the resistance of the electrically-resistive element 72 also changes, reducing the flow of electrical current to the release system 70. The decrease in electrical current reduces the strength of the magnetic field generated by the release system 70 until it can no longer maintain the control element 18 in the raised position 19. Accordingly, the control element 18 automatically falls under the action of gravity to the lower position 19′, slowing the rate of reaction in the core 16 and causing the reactor 14 to shut down.

It is readily apparent that there are various design considerations that will affect the performance of the automatically scramming nuclear reactor system 10 of the present invention. These design considerations may include the position of the guide(s) 50 in the core 16 of the reactor 14 to target areas of greater neutronic importance. Other design considerations may include any of a number of factors that may be varied to optimize the configuration of the control element(s) 18, such as but not limited to the size, shape, and/or mass of the control element 18. Yet other design considerations may include factors that may be varied to adjust the sensitivity of the resistive element(s) 72 to changes in temperature. Still other design parameters will become readily apparent to one skilled in the art after having become familiar with the teachings of the present invention.

It is also readily apparent that according to embodiments of the invention the automatic scramming system 10 responds to changes in the temperature of the core 16 to automatically lower the control elements 18 into the reactor 14 under the force of gravity to shut down the reactor 14 before it can overheat. Consequently, the claimed invention represents an important development in the field of nuclear power generation.

Having herein set forth preferred embodiments of the present invention, it is anticipated that suitable modifications can be made thereto which will nonetheless remain within the scope of the present invention. Therefore, it is intended that the appended claims be construed to include alternative embodiments of the invention except insofar as limited by the prior art.

What is claimed is:

1. An automatically scramming nuclear reactor system, comprising:
a core;
a control element moveable relative to said core between an upper position and a lower position;
an electrically-resistive element positioned in thermal contact with said core, said electrically-resistive element having a variable resistance that changes in response to a change in temperature of said core;
a release system positioned adjacent said core, said release system operatively associated with said electrically-resistive element, said release system holding said control element in the upper position during a normal operating condition of said nuclear reactor system, and said release system releasing said control element when the temperature of said core changes from a safe operating temperature so that said control element automatically falls under the action of gravity to the lower position.

2. The nuclear reactor system of claim 1, wherein resistance produced by said electrically-resistive element increases as the temperature of said core increases.

3. The nuclear reactor system of claim 1, wherein resistance produced by said electrically-resistive element increases as the temperature of said core decreases.

4. The nuclear reactor system of claim 1, wherein said control element comprises a ferromagnetic portion and a control material portion.

5. The nuclear reactor system of claim 4, wherein said release system comprises an electromagnet.

6. The nuclear reactor system of claim 1, wherein said electrically-resistive element is comprised primarily of iron.

7. The nuclear reactor system of claim 1, wherein said electrically-resistive element has a melting temperature higher than a maximum expected temperature of said core.

8. The nuclear reactor system of claim 1, further comprising a voltage source connected in series with said electrically-resistive element and said release system.

9. The nuclear reactor system of claim 8, further comprising at least one fuse connected in series with said voltage source, said fuse limiting the electrical current provided by said voltage source.

10. The nuclear reactor system of claim 1, further comprising a guide positioned within said core, said control element moveable along said guide into said lower position.

11. The nuclear reactor system of claim 1, further comprising a guide positioned adjacent said core, said control element moveable along said guide into said lower position.

12. The nuclear reactor system of claim 1, wherein said electrically-resistive element is positioned within said core.

13. An automatically scramming nuclear reactor system, comprising:
a core;
an electrically-resistive element positioned in thermal contact with said core, said electrically-resistive element having a variable resistance that changes with a change in temperature;
a voltage source;
a control element, said control element being moveable with respect to said core between an upper position and a lower position; and
an electromagnet positioned adjacent said core, said electromagnet being electrically connected in series with said electrically-resistive element and said voltage source, said electromagnet holding said control element in the upper position during a normal operating condition of said reactor, said electromagnet releasing said control element when a temperature of said core changes from a safe operating temperature, said control element automatically falling under the action of gravity to the lower position when released by said electromagnet.

14. The nuclear reactor system of claim 13, wherein resistance produced by said electrically-resistive element increases as the temperature of said core increases.

15. The nuclear reactor system of claim 13, wherein resistance produced by said electrically-resistive element increases as the temperature of said core decreases.

16. The nuclear reactor system of claim 13, wherein said electrically-resistive element is positioned within said core.

17. The nuclear reactor system of claim 13, wherein said control element comprises a ferromagnetic portion and a control material portion.

18. The nuclear reactor system of claim 13, further comprising a guide positioned within said core, said control element operatively associated with said guide so that said guide guides said control element between the extended and lower positions.

19. The nuclear reactor system of claim 18, wherein said guide comprises an elongate tube member having an open interior portion sized to slidably receive said control element.

20. The nuclear reactor system of claim 13, further comprising a guide positioned adjacent said core, said control element operatively associated with said guide so that said guide guides said control element between the extended and lower positions.

21. The nuclear reactor system of claim 13, wherein said electrically-resistive element has a melting temperature higher than a maximum expected temperature of said core.

22. The nuclear reactor system of claim 13, wherein said electrically-resistive element is comprised primarily of iron.

23. A method for scramming a nuclear reactor system, comprising:
placing an electrically-resistive element in thermal contact with a core of said nuclear reactor system, said electrically-resistive element having a variable resistance that changes in response to a change in temperature of the core;
connecting an electromagnet in series with said electrically-resistive element and a voltage source; and
engaging a control element with the electromagnet, said control element being moveable with respect to the core between an upper position and a lower position, the electromagnet holding said control element in the upper position during a normal operating condition of said reactor, said electromagnet releasing said control element when a temperature of said core changes from a safe operating temperature, said control element automatically falling under the action of gravity to the lower position when released by said electromagnet.

24. An automatically scramming nuclear reactor system, comprising:
a core;
control means for scramming said core when said control means is lowered into said core;
a voltage source;
electrical-resistance means provided in thermal contact with said core for providing a variable resistance that changes with a change in temperature; and
release means positioned adjacent said core, said release means electrically connected in series with said voltage source and said electrical-resistance means for releasing said control means when a temperature of said core changes from a safe operating temperature, said control means automatically falling under the action of gravity when released by said release means.

25. The nuclear reactor system of claim 24, further comprising guide means positioned within said core for guiding said control means into said core.

26. The nuclear reactor system of claim 24, further comprising guide means positioned adjacent said core for guiding said control means into said core.

27. An automatically scramming nuclear reactor system, comprising:
a core;
a control element movable relative to said core between an upper position and a lower position;
a voltage source having a first terminal and a second terminal;
an electrically-resistive element having a first lead and a second lead, the first lead being connected to the first terminal of said voltage source, said electrically-resistive element positioned in thermal contact with said core and producing a variable resistance in response to an increase in a temperature of said core;
a release system having a first terminal and a second terminal, the first terminal of said release system being connected to the second lead of said electrically-resistive element, the second terminal of said release system being connected to the second terminal of said voltage source, said release system being positioned adjacent said core, said voltage source providing an electrical current to said release system to hold said control element in the upper position during a normal operating condition of said nuclear reactor system, said electrically-resistive element reducing the electrical current to said release system when the temperature of said core exceeds a safe operating temperature so that said release system automatically releases said control element to fall under the action of gravity to the lower position.

28. The nuclear reactor system of claim 27, wherein said release system comprises an electromagnet and wherein said control element comprises a ferromagnetic portion.
